(19) United States
(12) Patent Application Publication
(10) Pub. No.: US 2010/0037234 A1
(43) Pub. Date: Feb. 11, 2010

(54) DATA PROCESSING SYSTEM AND METHOD OF TASK SCHEDULING

(75) Inventors: NARENDRANATH UDUPA, BANGALORE (IN); NAGARAJU BUSSA, BANGALORE (IN)

Correspondence Address: HEAD, JOHNSON & KACHIGIAN, 228 West 17th Place, Tulsa, OK, 74119, US

(73) Assignee: KONINKLIJKE PHILIPS ELECTRONICS, N.V., EINDHOVEN (NL)

(21) Appl. No.: 11/813,808

(22) PCT Filed: Jan. 9, 2006
(86) PCT No.: PCT/IB06/50071

§ 371 Date: Jul. 12, 2007

(30) Foreign Application Priority Data
Jan. 13, 2005 (EP) 05100179.0

(51) Int. Cl. G06F 9/48

(52) U.S. Cl. 718/107

(57) ABSTRACT

A data processing system in a multi-tasking environment is provided. The data processing system comprises at least one processing unit (1) for an interleaved processing of the multiple tasks. Each of the multiple tasks comprises available data associated to it and a corresponding waiting time. In addition, a task scheduler (2) is provided for scheduling the multiple tasks to be processed by the at least one processing unit (1). The task scheduling is performed based on the amount of data available for the one of the multiple tasks and based on the waiting time of the data to get processed by that task.

The invention relates to a data processing system in a multi-tasking environment as well as a method for task scheduling within a multi-tasking data processing environment.

In order to improve the performance of novel multiprocessors or multi-core systems, several tasks are performed by the operating system, substantially concurrently or in an interleaved manner by switching between the multiple tasks through task scheduling. The task scheduling technique may include Round Robin, priority based like RMA, or deadline based like EDF algorithms. In a task scheduling based on Round Robin fashion the runnable tasks are checked in a Round Robin technique and a task is selected to be processed on the processor or processing unit. In priority based task scheduling, the scheduling of the next task to be performed on the processing unit is based on the priority of each of the tasks determined either statically or dynamically. The selection of the task is performed statically as in RMA, dynamically as in EDF based on the frequency of task, i.e. number of times per second, or based on a deadline, i.e. cycles remaining, respectively. EDF can be considered as the best scheduling algorithm, however, due to the complexity of determining the cycles remaining, it is not feasible to perform the task scheduling at run time and on the fly. Therefore, the EDF technique has not been preferred in practical embedded systems. The usage of the frequency of task for determining the static priority like in RMA is a simple but very powerful and effective task scheduling technique. If the dynamic data appearance for the processing is not regular but irregular, the technique based on frequency of task is not able to perform an efficient scheduling especially for highly-data dependent task.

In the case of existing scheduling techniques, irregularity of the data appearance, can lead to unnecessary expensive context switches and associated performance fallouts such as cache corruption, cache misses and excessive bus traffic.

In the case of a static priority scheduling scheme, a task switching may be performed for a task being ready but with less data than required to process for a significant time, such that a context switch is performed too soon.

It is an object of the invention to provide a data processing system with an improved task scheduling to also effectively process data appearing irregularly.

This object is solved by a data processing system according to claim 1 and by a method for task scheduling within a data processing system according to claim 4.

Therefore, a data processing system in a multi-tasking environment is provided. The data processing system comprises at least one processing unit for an interleaved processing of the multiple tasks. Each of the multiple tasks comprises available data associated to it and a corresponding waiting time. In addition, a task scheduler is provided for scheduling the multiple tasks to be processed by the at least one processing unit. The task scheduling is performed based on the amount of data available for the one of the multiple tasks and based on the waiting time of the data to get processed by that task.

Accordingly, it can be avoided that any one of the tasks is starved, i.e. not scheduled. As the task scheduling is based on the amount of data and the waiting time of the data, both parameters will influence the task scheduling.

According to an aspect of the invention, the task scheduler performs the scheduling of the multiple tasks based on the product of the amount of data and the waiting time of the data to be processed by a task. Therefore, a trade off between the amount of data and the waiting time can be performed such that a large amount of data even for a small waiting time, will increase the probability of a respective task scheduling while on the other hand a long waiting time even for a small amount of data will also increase the probability of a task scheduling.

The invention also relates to a method for task scheduling within a multi-tasking data processing environment. All tasks ready to be processed are identified, wherein each of the multiple tasks comprises available data associated to it and a corresponding waiting time. The amount of available data associated to each of the tasks ready to be processed as well as the waiting time of this data is determined. The tasks are switched according to the amount of available data and the waiting time of this data.

According to a further aspect of the invention, the amount of available space for writing data of a task as well as the waiting time of this data is also influencing the task scheduling.

These and other aspects of the invention are apparent from and will be elucidated with reference to the embodiments described hereinafter and with respect to the following figures.

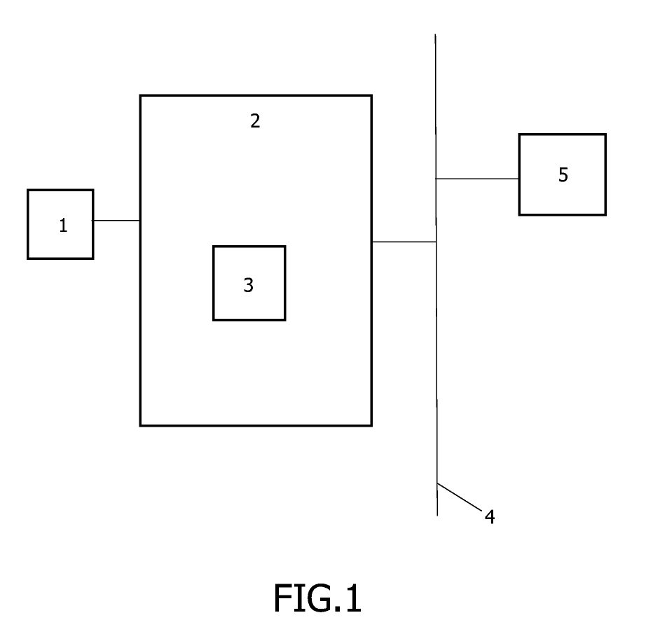

FIG. 1 shows a block diagram of a basic structure of a data processing system according to a first embodiment, and

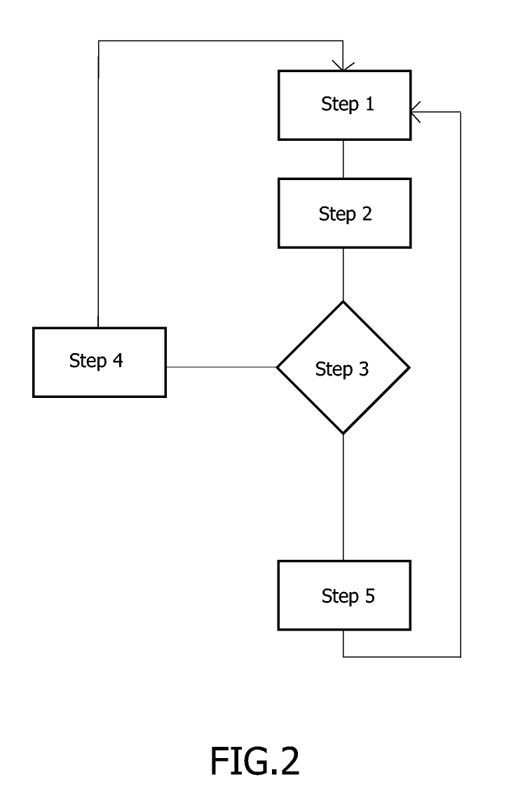

FIG. 2 shows a flow chart of the process of task scheduling according to the first embodiment.

FIG. 1 shows a data processing system in a multi-tasking environment. The data processing system comprises at least one processing unit 1, a task scheduler 2, a cache 3, a bus 4 and a main memory 5. The processing unit 1 is connected via the task scheduler 2 and a cache 3 to the bus 4. The main memory 5 can also be connected to the bus 4. Although only one processing unit 1 is explicitly shown in FIG. 1, also other processing units can be included into the data processing system according to FIG. 1.

Preferably, the data processing system according to FIG. 1 is designed for streaming application. Several tasks or multiple tasks are mapped onto the processing unit 1 in order to improve the efficiency of the processing unit by an interleaved processing. As several tasks are to be processed by the data processing unit 1, some of the tasks may still be waiting on data availability in the cache 3 or the memory 5 while other tasks already comprise data therein, such that the processing unit 1 can immediately start with the processing thereof. Such tasks having data for processing may be referred to as ready tasks. The tasks, which are still awaiting any data to be processed, may be referred to as blocked tasks. Accordingly, several of the ready tasks may be waiting for their execution by the processing unit 1 if their data has for example already been available in the cache 3 or the memory 5.

According to the present invention, a dynamic scheduling algorithm is provided, which takes into account the amount of data and the waiting time associated with this data for scheduling one of the ready tasks. The product of the available data size in bytes and the current waiting time of this data in cycles may be referred to as data momentum.

For example, a first task T₁ will become a ready task if data d₁ is available for processing by the processing unit 1. It is assumed that the task has sufficient space to write to the output. After t₁ cycles, data d₂ is also available for processing. At the end of t₂ cycles (t₂>t₁), the product of the data and its waiting time is defined as M₁(t)=d₁*t₂+d₂*(t₂−t₁). Such a product is called data momentum in byte-cycles. This can be calculated for all ready tasks.

Furthermore, consider the tasks T₁, T₄ and T₆ as mapped on the processing unit PU₁ and task T₁ and task T₆ constitute ready tasks, while task T₄ constitutes a blocked task. The product or data momentum M₁ (t) and M₆ (t) are calculated for the ready tasks T₁ and T₆. Then it is determined which of the two tasks T₁, T₆ comprises the higher product or data momentum and this task is scheduled to be processed next, i.e. as next running task. The product or data momentum is increasing every cycle until the task is finally scheduled due to at least the increased data waiting time. As soon as the task is scheduled to be processed by the processing unit, the data of the task will be consumed because of the processing on the processing unit such that the product or data momentum of the task will start to decrease such that the task may even be replaced by another runnable task from the ready list having a higher momentum.

The actual task scheduling may be performed according to two ways, namely by scheduling out or scheduling in. If a ready task is scheduled in, i.e. selected as running task, then the task is chosen which comprises the highest data momentum or product among the ready tasks. If a schedule out strategy is performed, a currently running task will be replaced if its data momentum is less than a definite percentage of the data momentum of any of the remaining ready tasks. A typical number may be 50%. However, also other numbers can be selected.

The data momentum M_{T}(t), can be calculated as a function of time t, of the ready task T having D blocks of data d₁, d₂, . . . d_{D}, wherein the data blocks arrive at time instances t_{d1}, t_{d2}, . . . , t_{dD}, as follows

M_{T}(t)=d₁*(t−t_{d1})+d₂*(t−t_{d2})+ . . . +d_{D}*(t−t_{dD}) (1)

Accordingly, the data momentum may also be calculated as follows:

$${M}_{T} ( t ) = {\sum }_{i = 1}^{D} {d}_{i} * ( t - {t}_{di} ) \qquad ( 2 )$$

FIG. 2 shows a flow chart of a task scheduling according to the first embodiment. In step 1, all ready tasks are identified and listed. In step 2, the data momentum according to equation (1) or (2) is calculated for each of the ready tasks as well as for the running task, i.e. the task currently been processed by the processing unit. In step 3, it is determined whether the data momentum of the running task is more than a fixed percentage say, 50%, of the highest data momentum of the listed ready tasks. If this is true the running task will be executed in step 4 and the flow will go to step 1. In step 5, the actually running task is scheduled out and one of the ready tasks, which comprise the highest data momentum, is scheduled to be processed by the processing unit. Thereafter, the flow goes to step 1.

According to a second embodiment which is preferably based on the first embodiment, the availability of space for writing the output may also be added in the equations (1) or (2). Accordingly, if two tasks nearly have the same amount of data momentum, the actual availability of space can be used to differentiate between the two tasks. The task having more space momentum, i.e. more space for writing data for longer time, is preferred over a task having less space momentum.

The space momentum can be calculated as a function of time t of the ready task T having D blocks of space for writing, e.g. s₁, s₂, . . . s_{D}, wherein the space for writing the data blocks appear at time instances tₛ₁, tₛ₂, . . . , t_{sD}. The space momentum can therefore be calculated as follows:

M_{T}(t)=s₁*(t−tₛ₁)+s₂*(t−tₛ₂)+ . . . +s_{D}*(t−t_{sD}) (3)

Accordingly, the space momentum may also be calculated as follows:

$${M}_{T} ( t ) = {\sum }_{i = 1}^{D} {s}_{i} * ( t - {t}_{si} ) \qquad ( 4 )$$

If the space is not available for a task to write the output, but the data momentum is highest amongst the ready tasks, then scheduling the task will not help, as the context switch will occur immediately, such that the purpose of data momentum based task scheduling is made obsolete. Hence, a comprehensive momentum is defined for each of the tasks, which could be defined as the PRODUCT or MIN operation on the data momentum and space momentum.

In another embodiment of the invention, the comprehensive momentum of the task can be used as a parameter for scheduling the multiple tasks.

Accordingly, the comprehensive momentum may be calculated as follows:

$${M}_{T} ( t ) = [ {\sum }_{i = 1}^{D} {d}_{i} * ( t - {t}_{di} ) ] AND [ {\sum }_{i = 1}^{D} {s}_{i} * ( t - {t}_{si} ) ] \qquad ( 5 )$$

The task scheduler selects the task, which has the highest comprehensive momentum amongst the ready tasks, to be processed by the processing unit. The scheduling out is performed if the comprehensive momentum of the running task is less than e.g. 0.5 times of the highest comprehensive momentum of the remaining tasks in the ready list.

Alternatively or additionally the task scheduling may also be performed based on the above described space momentum.

The above described data processing system constitutes a multi-processing architecture for processing streaming audio/video applications. The above described principles of the invention may be implemented in a next generation TriMedia or other media processors.

It should be noted that the above-mentioned embodiments illustrate rather than limit the invention, and that those skilled in the art will be able to design many alternative embodiments without departing from the scope of the appended claims. In the claims, any reference signs placed between parenthesis shall not be construed as limiting the claim. The word “comprising” does not exclude the presence of elements or steps other than those listed in a claim. The word “a” or “an” preceding an element does not exclude the presence of a plurality of such elements. In the device claim in numerating several means, several of these means can be embodied by one and the same item of hardware. The mere fact that certain measures are resided in mutually different dependent claims does not indicate that a combination of these measures cannot be used to advantage.

Furthermore, any reference signs in the claims shall not be constitute as limiting the scope of the claims.

1. Data processing system in a multi-tasking environment, comprising:
at least one processing unit (1) for interleaved processing of multiple tasks, wherein each of said multiple tasks comprises available data associated to it and a corresponding waiting time;
a task scheduler (2) for scheduling the multiple tasks to be processed by the at least one processing unit (1) based on the amount of data available for a specific task and the corresponding waiting time of a task.

2. Data processing system according to claim 1, wherein
the task scheduler (2) is adapted to perform the scheduling of the multiple tasks based on a product of the amount of available data and the waiting time of one of the multiple tasks.

3. Data processing system according to claim 1 wherein
the task scheduler (2) is adapted to perform the scheduling of the multiple tasks based on the sum of the products of a data block of the available data and its associated waiting time of one of the multiple tasks.

4. Method for task scheduling within a multi-tasking data processing system, comprising the steps of:
identifying all tasks ready to be processed, wherein each of said multiple tasks comprises available data associated to it and a corresponding waiting time;
determining an amount of available data associated to each of the tasks ready to be processed as well as a time the data is waiting for each of the tasks ready to be processed;
task scheduling according to the amount of available data and waiting time of the data of the tasks ready to be processed.

5. Method for task scheduling according to claim 4, comprising the steps of:
determining the amount of available data and the corresponding waiting time of the currently processed task,
comparing these results with the amount of available data and the corresponding waiting time associated to each of the tasks ready to be processed, and
scheduling out the currently processed task if the amount of available data and the associated waiting time is less than a predefined percentage of the amount of available data and the corresponding waiting time of the tasks ready to be processed.

6. Method for task scheduling according to claim 4 further comprising the steps of:
determining the amount of available space for writing data associated to each of the tasks ready to be processed as well as the waiting time for the data to be written for each of the tasks ready to be processed,
wherein the task switching is based on the amount of available space for writing data and the waiting time of the data to be written.
